(19) United States
(12) Patent Application Publication
(10) Pub. No.: US 2003/0206197 A1
(43) Pub. Date: Nov. 6, 2003

(54) Personal information management devices with persistent application information and methods

(76) Inventor: John McInerney, Belvidere, IL (US)

Correspondence Address: MOTOROLA INC, 600 NORTH US HIGHWAY 45, LIBERTYVILLE, IL, 60048-5343, US

(21) Appl. No.: 10/139,843

(22) Filed: May 6, 2002

(51) Int. Cl. G09G 5/00

(52) U.S. Cl. 345/764; 345/786

(57) ABSTRACT

A handheld personal information management (PIM) device (100) including a processor (110) with memory, a user input interface (120), a display (130), and a plurality of application information display elements displayed in a series on a dedicated portion of the display of the personal information management device. In one embodiment, the display elements are displayed continually on the display, and in another embodiment the display elements are updated periodically, for example by scrolling the display elements along a portion of the display.

### FIELD OF THE INVENTIONS

The present inventions relate generally to personal information management (PIM) devices, and more particularly to personal information management devices with persistent application information, for example continual display of scheduled calendar event information, PIM devices and methods therefor.

### BACKGROUND OF THE INVENTIONS

Many handheld personal information management (PIM) devices have limited processing, memory, display and power resources that impose substantial limitations on software applications. Many PIM devices having small displays, including cellular telephone handsets, personal digital assistants (PDAs), among other handheld devices, are incapable of simultaneously displaying data from multiple applications, for lack of sufficient display area. Some PIM devices, for instance, cannot display calendar application information and address application information at the same time.

Productivity and other applications that require substantial time or effort to operate are generally unappealing to end-users. These types of applications are likely to be underutilized. For example, exiting one application, navigating to another application, for example a calendar to determine whether an event is scheduled, and then restarting the original application is time wasted, and often so troublesome that users may forego utilization of the calendar application.

The various aspects, features and advantages of the present invention will become more fully apparent to those having ordinary skill in the art upon careful consideration of the following Detailed Description of the Invention with the accompanying drawings described below.

### BRIEF DESCRIPTION OF THE DRAWINGS

FIG. 1 is an exemplary mobile wireless communication enabled PIM device.

FIG. 2 is a schematic diagram of an exemplary application program.

FIG. 3 is an exemplary a plurality of calendar application display elements displayed in a series across a PIM display.

FIG. 4 is an exemplary PIM device calendar event schedule.

FIG. 5 is an exemplary a plurality of calendar application display elements displayed in a series across a PIM display.

FIG. 6 is an exemplary PIM device calendar event schedule.

FIG. 7 is an exemplary process flow diagram.

### DETAILED DESCRIPTION OF THE INVENTIONS

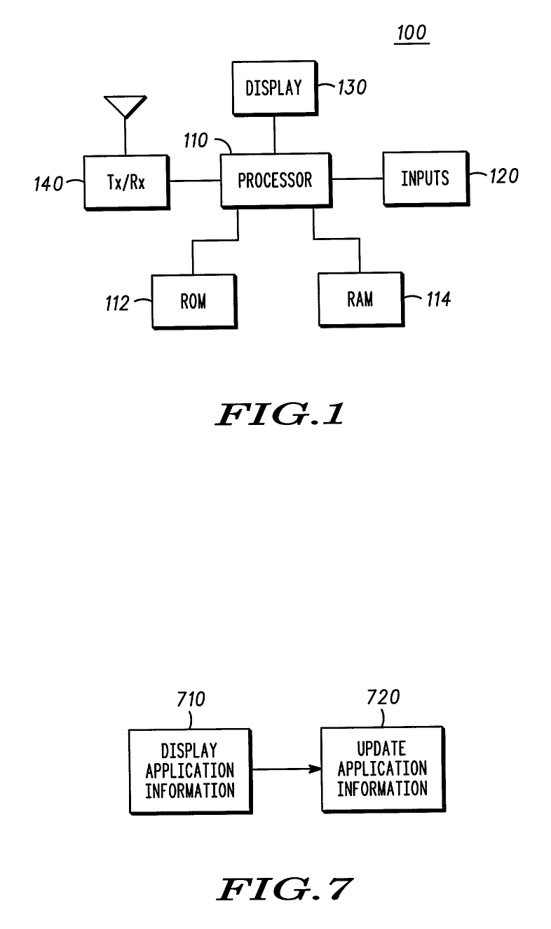

FIG. 1 is an exemplary handheld personal information management (PIM) device 100 comprising generally a processor 110 with memory, typically including ROM 112 and RAM 114, and possibly other memory devices, for example a programmable EEPROM and/or a removable memory component. The PIM device also comprises a user input interface 120 including, for example, a keypad or keyboard or joystick or pointer, and other input devices coupled to the processor. A display 130, for example, a liquid crystal or an electroluminescent or some other display device, is also coupled the processor.

In FIG. 1, the exemplary PIM device is a mobile wireless communications device including a transceiver 140, for example a W-CDMA or GSM or some other wireless communications device, coupled to the processor. Alternatively, the PIM device may be a handheld personal digital assistant or a personal organizer or some other handheld device with or without a transceiver.

In one embodiment, in FIG. 2, a calendar application program 200 resides in memory of the PIM device, although in other embodiments various features and aspects of the invention are applicable to application programs other than calendar applications. The inventions pertain more generally to any application program having application information that may be represented by display elements that are displayable on a display device, and to applications for which it is desirable to update displayed application information, for example by changing a visual characteristic of the corresponding display element.

The exemplary calendar application program includes a calendar information indicator, or display element, generation segment 210 stored in the memory. The calendar information display element generation segment generates a plurality of calendar information display elements for display on the PIM device display. Other non-calendar application programs will have similarly a corresponding display element generation segment.

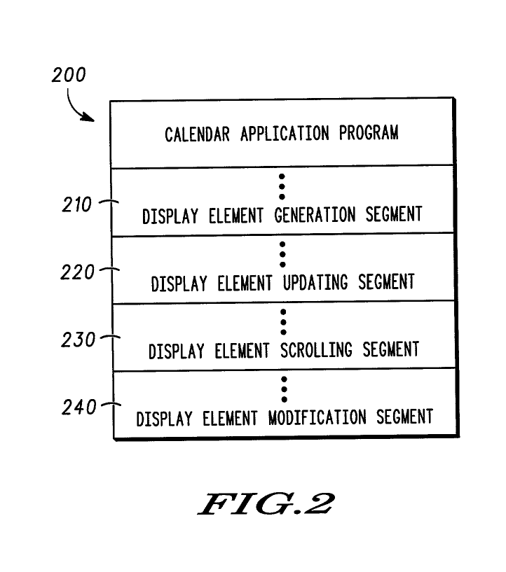

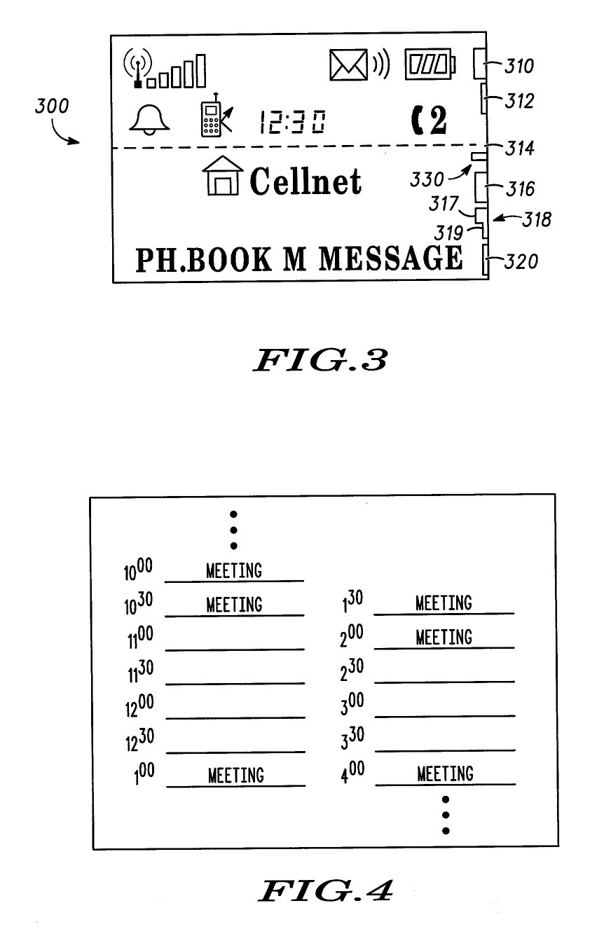

In one embodiment, the PIM device includes a plurality of calendar information display elements continually displayed in a series on a dedicated portion of the display. In FIG. 3, for example, a PIM device display 300 includes a series of display elements, or visual indicators, 310, 312, 314, 316, 318 & 320 displayed on a dedicated portion of the display, along the right-hand edge thereof.

In other embodiments, the plurality of calendar elements may be displayed along the left-hand side of the display or along the top or bottom thereof. In another embodiment, calendar information is displayed on any other portion of the display, not limited to the sides or top and bottom, for example on a cellular communication handset during idle mode. In one embodiment, the user may select which portion of the display device is dedicated to displaying the plurality of calendar information elements, for example, by making a selection in a user configuration menu.

In one embodiment, each of the display elements corresponds to a particular interval of time. In the exemplary calendar application embodiment, each display element corresponds to a 60-minute time interval. In other embodiments, however, each of the plurality of display elements may correspond to some other time interval, for example, 15 minutes, or 30 minutes, or a day. In some embodiments, each display element corresponds to a time interval designated by a device user, for example in a configuration menu.

In FIG. 3, there is a current time pointer or reference 330 on the display for which of the display elements correspond to a current time or event. In one embodiment, the pointer 330 is fixed and display elements are scrolled past the fixed pointer. In other embodiments, the display elements are fixed and the pointer move across the display relative to the fixed display elements.

In one embodiment, in FIG. 2, the calendar application program includes a calendar information updating segment 220. The updating segment updates the calendar information display elements along the display of the personal information management device, for example by adding a new display element corresponding to a future time, and deleting an old display element corresponding to a past time when adding the new display element. Other non-calendar application programs may also have a corresponding display element updating segment.

In one embodiment, in FIG. 2, the calendar application program includes a calendar information scrolling segment 230. In one embodiment, the calendar information scrolling segment is a calendar display element scrolling segment that scrolls a plurality of display elements along at least a portion of the display. Alternatively, the calendar information scrolling segment may move the reference pointer relative to fixed display elements. In one embodiment, the scrolling rate is proportional to the time interval assigned to the display elements. For example, if each display element corresponds to a 1-hour time interval, a new display element is added and an old display element is removed every hour. Other non-calendar application programs may also have a corresponding display element scrolling segment, if scrolling is desired.

In FIG. 3, the display elements 310, 312, 314, 316, 318 and 320 may be scrolled up or down. In embodiments where the display elements are arranged in a series across the display, the display elements may be scrolled across the display in either the left or right directions. In some embodiments, a scroll direction symbol on the display, for example, an arrowhead, indicates the scrolling direction.

In one embodiment, the display elements are displayed continually, and updated periodically. For example, the calendar information display elements may be displayed continually while running applications other than the calendar application. It is not necessary, however, for the calendar application to be running at all times, for example the display elements may be calendar status indicators that are updated occasionally.

The exemplary calendar application program includes a calendar information indicator modification segment 240 that modifies the plurality of calendar information elements, or display elements, based upon user event data input, for example based upon whether a calendar event has been scheduled for the time interval corresponding to a particular display element, as discussed more fully below.

In other embodiments, the display elements may correspond to attributes other than “event scheduled”, for example, “busy” or “tentative”. These and other attributes may be distinguished from each other with different display element shapes or colors. Generally, a display element may correspond to more than one attribute, for example its shape may indicate that a “scheduled event” and its color may indicate that the scheduled event is “tentative.”

In one embodiment, the plurality of display elements, displayed on the PIM device, are configured to visually indicate scheduled calendar events by visually differentiating the display elements corresponding to time intervals during which events are scheduled from display elements corresponding to time intervals during which event are not scheduled.

In FIG. 3, for example, the display elements 310 & 316, corresponding to times of the day during which events are scheduled in the calendar program, are larger than display elements 312, 314 & 320, which correspond to times during which no events are scheduled. An event is scheduled for only a portion of the time interval corresponding to display element 318. In the exemplary embodiment, the display elements corresponding to time intervals during which events are scheduled are designated by illuminating a 4 pixel by 10 pixel display area, as illustrated in FIG. 3 for display elements 310, 316 and a portion 317 of display element 318.

The display elements corresponding to time intervals during which events are not scheduled are designated by illuminating a right side 2 pixel by 10 pixel display area, as illustrated in FIG. 3 for display elements 312, 320 and a portion 319 of display element 318. In other embodiments, other area dimensions and calendar information indicator shapes may be employed. Also, the display elements may be differentiated alternatively using different colors or different shapes or different symbols or text or combinations thereof.

In FIG. 3, the display element 314 adjacent the reference pointer 330 corresponds to the current time interval, 12:00-1:00. Display element 314 is thus the current display element. In the exemplary embodiment, the current display element is indicated by de-illuminating the right column 2 pixel by 10 pixel display area of the display element. In other embodiments, the current display element may be designated with a different color or different shape or a symbol or some other visual indicator.

In FIG. 4, the calendar application program includes an event scheduled in 30 minute time periods between 10:00 am and 11:00 am and another event scheduled between 1:00 pm and 2:30 pm. The event schedule information is typically entered by the user, for example at an input menu of the calendar application program. The partial event schedule illustration of FIG. 3 merely indicates the relationship between scheduled events and display elements, and is not necessarily representative of the form in which the data is entered or stored the application program.

In FIG. 3, the current time is 12:30 pm, and display elements 310, 312, 314, 316, 318 and 320 are scrolled from the bottom toward the top of the display 300. Each exemplary display element corresponds to a 1-hour time interval. The display element 314, corresponding to the 12:00-1:00 pm time interval, is adjacent the current time pointer 330. In FIG. 3, the right column 2 pixel by 10 pixel portion of the display element 314 is blank to indicate that display element 314 corresponds to the current time interval. In FIG. 3, no event is scheduled for the 12:00-1:00 pm time interval, so the left column 2 pixel by 10 pixel display area portion is not illuminated.

FIG. 5, discussed further below, illustrates how the current display element looks when it corresponds to a time interval during which an event is scheduled, as discussed further below.

In FIG. 4, the time interval 1:00-2:30 pm has a “MEETING” event scheduled. In FIG. 3, the display element 316, corresponding to the 1:00-2:00 pm time interval has a relatively large size, and the portion 317 of the display element 318 corresponding to the 2:00-2:30 pm time interval also has a relatively large size. The remaining portion 319 of the display element 318 has a small size, since no event is scheduled for the 2:30-3:00 pm time interval. In FIG. 4, the next time interval 3:00-4:00 pm has no event scheduled, so in FIG. 3 the display element 320 has a small size. In FIG. 3, the display element 312, corresponding to the earlier 11:00-12:00 am time interval, also has a small size, since no event was scheduled. The display element 310, corresponding to the earlier 10:00-11:00 am time interval, however has a large size, since a “MEETING” event was scheduled during that time interval, as illustrate in FIG. 4.

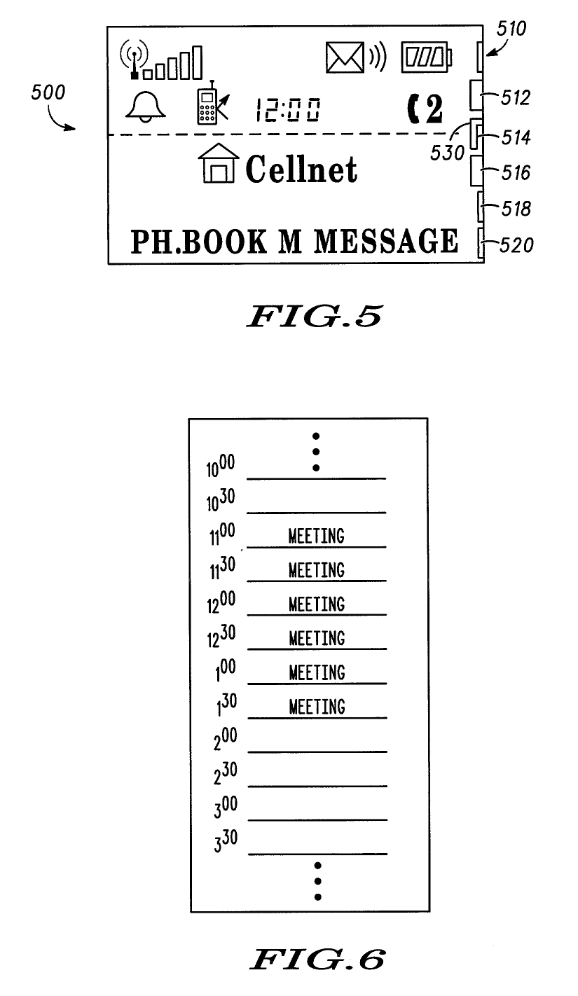

In FIG. 5, the current time is 12:00 pm, and the display elements 510, 512, 514, 516, 518 and 520 are scrolled from the bottom toward the top of the display 500. Each exemplary display element corresponds to a 1-hour time interval. The display element 514, corresponding to the 12:00-1:00 pm time interval, is adjacent the current time pointer 530. In FIG. 5, the right column 2 pixel by 10 pixel display area portion of display element 514 is blank to indicate that display element 514 corresponds to the current time interval. In FIG. 6, an event is scheduled for the 12:00-1:00 pm time interval, so in FIG. 5 the left column 2 pixel by 10 pixel display area portion of the display element 514 is illuminated.

In FIG. 6, the time interval 1:00-2:00 pm has a “MEETING” event scheduled. In FIG. 5, the display element 516, corresponding to the 1:00-2:00 pm time interval has an enlarged size, 4 pixel by 10 pixel display area or element. In FIG. 6, the next time interval 2:00-4:00 pm has no event scheduled, so in FIG. 5 the display elements 518 and 520 have a small size. In FIG. 5, the display element 512, corresponding to the earlier 11:00-12:00 am time interval, has a large size, since an event was scheduled for this time interval, as illustrated in FIG. 6. The display element 510, corresponding to the earlier 10:00-11:00 am time interval, has a small size, since no event was scheduled during that time interval, as is illustrated in FIG. 6.

In other embodiments, the user may specify other settings according to personal preferences including, for example, number, size and shape of the display elements, when the display elements are displayed, the frequency with which the display elements are updated, where the display elements are displayed, color/grayscale, scrolling rate and direction, etc. These selections may be made, for example, at a user configuration menu of the corresponding application.

In FIG. 7, at block 710, application information, for example scheduled calendar event information, is displayed on the display of the personal information management (PIM) device. In one exemplary embodiment, the application information is displayed as a plurality of display elements in a series. In the exemplary calendar application, each of the plurality of display elements corresponds to a particular time interval. In some applications, the application information is displayed continually, which includes intermittent display of the information.

In FIG. 7, at block 720, application information displayed on the personal information management device display is updated over time, either continuously or periodically. In one embodiment, display elements corresponding to application information are updated by changing a visual characteristic of the display element, for example the shape or color or some other aspect thereof. In the exemplary calendar application, display elements corresponding to the various time intervals are visually differentiated depending on whether an event for the corresponding time interval has been scheduled. In some embodiments, the application information is updated by scrolling the plurality of display elements across at least a portion of the display, adding new display elements corresponding to future times while scrolling, and deleting old display elements corresponding to past times when adding the new visual indicators.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A method in a handheld personal information management device, comprising:
continually displaying calendar information of a calendar application on a portion of a display of the personal information management device;
updating the calendar information displayed on the display of the personal information management device.

2. The method of claim 1, updating the calendar information displayed by scrolling the calendar information displayed along the display.

3. The method of claim 1,
continually displaying the calendar information by displaying a plurality of display elements in a series, each of the plurality of display elements corresponding to a particular time interval;
indicating scheduled calendar events by visually differentiating display elements corresponding to time intervals during which events are scheduled from display elements corresponding to time intervals during which events are not scheduled.

4. The method of claim 3, updating the calendar information by scrolling the plurality of display elements across at least a portion of the display, adding a new display element corresponding to a future time while scrolling, and deleting an old display element corresponding to a past time when adding the new display element.

5. The method of claim 3, visually differentiating at least one of the plurality of display elements from other of the plurality of display elements.

6. The method of claim 1, continually displaying the calendar information at all operation times of the personal information management device.

7. The method of claim 1, continually displaying the calendar information on a dedicated display portion of the personal information management device while running non-calendar applications.

8. The method of claim 1,
continually displaying calendar information by displaying a plurality of display elements in a series, each of the plurality of display elements corresponding to a particular time interval.

9. The method of claim 7, visually differentiating at least one of the plurality of display elements from other of the plurality of display elements.

10. A method in a handheld personal information management device, comprising:
displaying a plurality of calendar information elements in a series on a display of the personal information management device,
each of the plurality of calendar information elements corresponding to a particular calendar time interval;
updating the plurality of calendar information elements over time.

11. The method of claim 10, indicating scheduled calendar events by visually differentiating at least a portion of the plurality of calendar information elements from other of the plurality of calendar information elements.

12. The method of claim 10, updating the plurality of calendar information elements by scrolling the plurality of calendar information elements relative to a reference indicator.

13. The method of claim 10, indicating scheduling information for the plurality of calendar information elements by visually modifying the calendar information elements.

14. The method of claim 13, visually modifying the calendar information elements by changing a color thereof.

15. The method of claim 13, visually modifying the calendar information elements by changing a shape thereof.

16. The method of claim 10, continually displaying the calendar information elements on the display of the personal information management device while running non-calendar application.

17. The method of claim 10, continually displaying the calendar information elements on the display of the personal information management device while operating the personal information management device.

18. The method of claim 10, continually displaying the calendar information elements on the display of the personal information management device.

19. A handheld personal information management device, comprising:
a processor with memory;
a user input interface coupled to the processor;
a display device coupled the processor;
a plurality of calendar information elements continually displayed in a series on a dedicated portion of the display of the personal information management device.

20. The handheld personal information management device of claim 19, a calendar application program stored in the memory, the calendar application program including a calendar information element generation segment, whereby the calendar information element generation segment generates the plurality of calendar information elements displayed on the display of the personal information management device.

21. The handheld personal information management device of claim 20, the calendar application program including a calendar information element scrolling segment, whereby the calendar information element scrolling segment scrolls the calendar information elements along the display of the personal information management device.

22. The handheld personal information management device of claim 20, the calendar application program including a calendar information element modification segment, whereby the calendar information element modification segment modifies the plurality of calendar information elements displayed on the display of the personal information management device based upon user event input data.

23. The handheld personal information management device of claim 20, the calendar application program including a calendar information element updating segment, whereby the calendar information element updating segment temporally updates the plurality of calendar information elements displayed on the display of the personal information management device.

24. The handheld personal information management device of claim 20 is a wireless mobile communications handset, a transceiver coupled to the processor.
